(19) United States
(12) Patent Application Publication
(10) Pub. No.: US 2009/0031383 A1
(43) Pub. Date: Jan. 29, 2009

(54) NETWORK BROADCAST METHOD

(76) Inventor: GEORGIOS MARGARITIS, Los Altos, CA (US)

Correspondence Address: Georgios Margaritis, 370 Verano Drive, Los Altos, CA, 94022, US

(21) Appl. No.: 12/172,661

(22) Filed: Jul. 14, 2008

Related U.S. Application Data
(60) Provisional application No. 60/951,875, filed on Jul. 25, 2007.

(51) Int. Cl. H04N 7/173

(52) U.S. Cl. 725/116

(57) ABSTRACT

In this invention a novel method is disclosed for transmitting information from a server to a plurality of client devices in a network. A plurality of client devices may request the same information from a server. The server, instead of sending multiple copies of the information to the client devices, sends the information to an intermediary replicating device. The replicating device replicates the information and sends at least a copy to each one of the client devices. If the information is not live but stored, grouping of the devices may be done, and each group receives the information simultaneously with other client devices in the same group, but at different times with devices in other groups.

This application claims the benefit of U.S. Provisional Application No. 60/951,875, filed on Jul. 25, 2007.

### FIELD OF THE INVENTION

The present invention relates to the field of Communication Networks and Network Broadcast Methods.

### BACKGROUND OF THE INVENTION

Broadcasting video content, such as TV programs, is done primarily using airwaves, satellite signals and cable. After the expansion of the Internet, video content has also being distributed to viewers through the Internet. However, one of the main issues with distributing video through a network is that a separate video stream has to be sent to each viewer by the broadcaster. For example, a TV program could be viewed by millions of viewers. If a broadcaster wanted to distribute such a TV program to all the viewers though a network, he would need a very large amount of bandwidth on his end to meet the demand. For example, a regular TV broadcast requires about 5 Mbits/sec bandwidth. Therefore, broadcasting to one million viewers would require the broadcaster to have about 5 Terabits/sec data bandwidth, which is an enormous bandwidth requirement.

In this patent, a novel method is introduced where a broadcaster can to meet the demands of clients, with minimal output bandwidth requirements. The method is applicable to any type of bandwidth demanding transmission from a broadcaster to a plurality of consumers, and is not limited to video content only.

### SUMMARY OF THE INVENTION

In this invention a novel method is disclosed for transmitting information from a server to a plurality of client devices in a network. When a plurality of client devices connected to the network request the same information from the server, the server, instead of sending multiple copies of the information to each one of the client devices, sends the information to at least one intermediary replicating device located close to the clients. The replicating device receives and replicates the information and sends a copy to each one of the client devices. A cascade of replicating devices can also be used. Various financial arrangements are possible between a broadcaster that operate the server, an intermediary that operates the replicating device and a plurality of clients that use the client devices.

### LIST OF FIGURES

FIG. 1 shows an embodiment of a typical network configuration associated with the present method.

FIG. 2 shows a second embodiment of a typical network configuration with a cascade of replicators associated with the present method.

### DESCRIPTION OF THE INVENTION

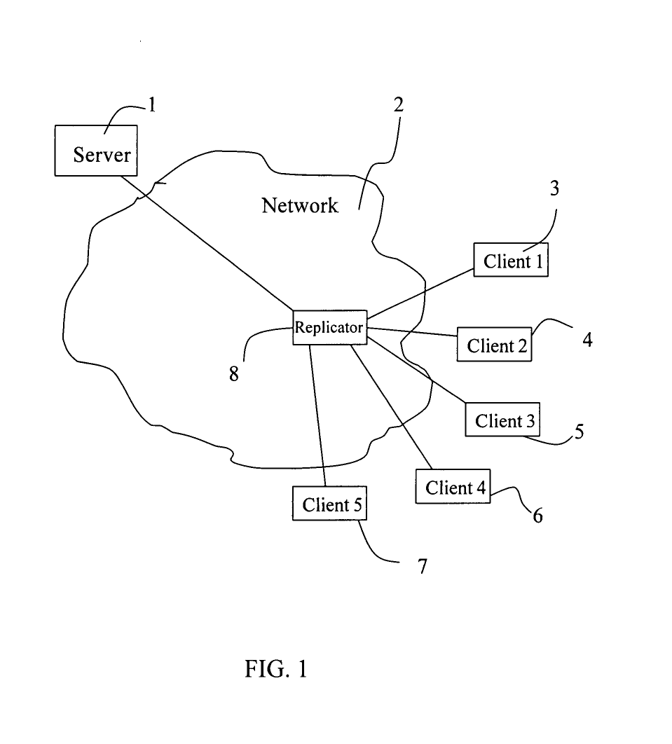

Referring to FIG. 1, a broadcaster has at least one server device 1, such as a computer, connected to a network 2, such as the Internet. One or more network operators operate and/or maintain the network 2 and provide end users access to the network. For example, AT&T communications can provide end users with DSL connections to its network, which is part of the Internet. Clients have client devices 3 to 7, such as computers, connected to the network 2, that can receive data from the server device 1. According to the present invention, the network operators have replicating devices 8, such as computers running appropriate software code, that can receive data from the broadcaster, replicate them, and forward them to a plurality of clients.

One embodiment of the method of this invention includes the following steps:
(a) A plurality of clients request a broadcast content from a broadcaster within a time interval. For example, a number of people may visit over, for example, five minutes the web site of a broadcaster, such as a TV station with Internet presence, for example ABC, and request to view a TV program, for example a news broadcast.
(b) Each client is identified by the received packets containing an identifying network address, such as the IP address of the client's computer. In other embodiments, the client could also be identified by logging onto an account with the broadcaster, or from computer cookies or any other client identifying means.
(c) Based on the received IP addresses, or login information, the broadcaster determines which network operator operates the network to which the client is directly linked.
(d) The broadcaster sends electronically at least one stream of broadcast data to each network operator and a list of clients within the network operators network that have requested the broadcast content.
(e) The network operator has installed appropriate equipment, information replicators or re-transmitters, such as those disclosed in US patent application 20070097970, that automatically receive the incoming broadcast stream and list of clients from the broadcaster and replicate the incoming broadcast stream from the broadcaster and re-transmits it to each one of the list of clients within the network.
(f) The broadcaster can charge clients on a monthly or any other time basis or on a pay per view basis, if the broadcast content is not free.
(g) The network operator can charge the broadcaster a fee per client serviced, for example per minute of broadcast per client.

Numerous other embodiments of the present invention are also possible. For example, a broadcaster can have an agreement with certain clients to continuously send broadcast data to them without waiting for a specific request. In such a case, the broadcaster can provide a network operator in advance with a list of clients and the network operator to configure its equipment to automatically replicate and broadcast the incoming broadcast stream from the broadcaster to the specified clients. The client list could be updated periodically as they subscribe to or unsubscribe from the service.

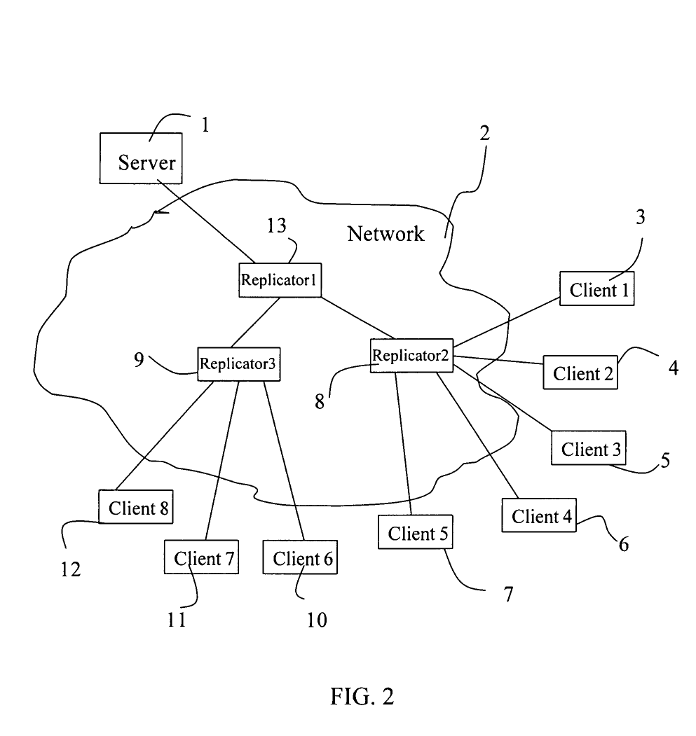

It is also possible, as shown in FIG. 2, that the stream from a broadcaster to a number of clients goes through a cascade of replicating devices, where each one of the first level of replicating devices receives the broadcast stream from the broadcaster replicates it and sends it to a second level of replicating devices and so on until the clients are reached.

In other embodiments, multiple streams of the same broadcast data are sent, separated by certain time intervals, so that clients requesting the data at different times do not have to wait for the initial broadcast to repeat but can access the broadcast stream that starts immediately after their request. For example, several thousand clients could request at random times to view a movie from a broadcaster. Instead of the broadcaster sending a broadcast stream to each one of these clients, which will consume its bandwidth, it can send a broadcast stream every, for example, five minutes. If the movie lasts, for example, two hours then the maximum number of broadcast streams the broadcaster will need to send is twenty-four. A requesting client can then start viewing the movie from the broadcast stream that starts in the next five minutes. In this manner, thousands or even millions of clients can be serviced from only a few broadcast streams initiating from the broadcaster, and the broadcaster will need only a fraction of the bandwidth that otherwise would be needed. For example, to service one million clients directly a broadcaster would need 5 Terabits/sec (1 million clients by 5 Mbits/sec/client) bandwidth. By using the method of the present invention he would need only a fraction of that, and in the example above, only 120 Mbits/sec (24 streams×5 Mbit/sec). In the case of multiple streams the broadcaster will have to send to the network operator a list of clients for each separate broadcast stream.

Another embodiment of the method of this invention includes the following steps:
1. A plurality of clients request a broadcast content from an intermediate server, for example replicator 8 of FIG. 1 could be an intermediate server in the network. For example, AT&T could have setup intermediate servers that clients can login to and request broadcast data from various broadcasters. It is noted that the intermediate server could also be operated by a company other than a network operator, and need not be a replicator.
2. Each client is identified by the received packets containing an identifying network address, such as the IP address of the clients computer, or from login information, or computer cookies or any other client identifying means.
3. The intermediate server requests the broadcast data from the broadcaster. It is also possible that if the broadcast is not live, the data have been pre-requested and stored locally and possibly replicated to be ready when a client requests them.
4. The broadcaster sends at least one copy of the broadcast data to the intermediate server.
5. The intermediate server replicates the incoming broadcast stream from the broadcaster and re-transmits it to each one of the requesting clients within the network.
6. Various financial agreements are possible between broadcaster, intermediary, and clients. For example, the intermediary can charge clients per request and pay a fee to the broadcaster per request, or have monthly, or other time-based, agreements with clients and broadcasters regardless of the number of requested broadcasts or any combination of pay per view or time-based agreements with clients and broadcasters.

Numerous other embodiments of the present invention are also possible. In general, the clients can request information of any type from a broadcaster directly or indirectly though intermediate servers or replicators. The server can send directly or indirectly, through intermediate replicators, the requested information to the clients. Also, some clients can receive the information directly from the server and others indirectly, through one or more replicators or cascade of replicators. Also, for stored information requests, the server or any of the replicators can group client devices in groups, based on a time or proximity scheme, and transmit the information simultaneously to all the devices of the same group. Also, in general, the method of this invention can be implemented in any network implementing any or a combination of network transmission protocols, such as Internet Protocol based networks, Ethernet, SONET or ATM based networks.

I claim:

1. A network broadcast method comprising the steps of:
a. establishing a server in a network
b. establishing at least one replicating device in the network that can receive and replicate information from said server
c. said replicating device receiving from said server specific information
d. said replicating device replicating said specific information
e. said replicating device sending at least one copy of said specific information to each one of a plurality of client devices

2. The method of claim 1 wherein said replicating device receives said specific information from said server through at least one higher level replicating device.

3. The method of claim 1 wherein said replicating device receives said specific information from said server through a cascade of higher level replicating devices.

4. The method of claim 1 wherein said replicating device stores a list of at least a portion of said plurality of client devices.

5. The method of claim 1 wherein said replicating device receives a list of at least a portion of said plurality of client devices.

6. The method of claim 1 wherein said specific information is live content.

7. The method of claim 1 wherein said specific information is stored content.

8. The method of claim 1 wherein at least a portion of said plurality of client devices has requested said specific information over a time interval.

9. The method of claim 1 wherein said replicating device stores at least a portion of said specific information.

10. A business method comprising the steps of:
a. a broadcaster establishing at least one server in a network
b. a broadcast intermediary establishing at least one replicating device in the network
c. a plurality of clients operating client devices
d. establishing financial arrangements between clients, intermediary and broadcaster to transmit the broadcast from the server to the client devices through the replicating device.
